(19) United States
(12) Patent Application Publication
(10) Pub. No.: US 2007/0122115 A1
(43) Pub. Date: May 31, 2007

(54) MULTI-AV STREAM PLAYBACK METHOD AND PLAYBACK APPARATUS

(76) Inventor: Kaoru UKAI, Ome-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/552,632

(22) Filed: Oct. 25, 2006

(30) Foreign Application Priority Data
Nov. 30, 2005 (JP) 2005-345912

(51) Int. Cl. H04N 7/00

(52) U.S. Cl. 386/95

(57) ABSTRACT

According to one embodiment, primary object data and secondary object data which include data unit groups having playback time information and which are temporally independent and are different from each other are synchronously played back. Playback time information is acquired from the played-back primary object data, and playback time information is acquired from the played-back secondary object data. Using one of the acquired playback time information of the primary object data and that of the secondary object data, the primary object data and the secondary object data are played back in sync.

### CROSS-REFERENCE TO RELATED APPLICATIONS

This application is based upon and claims the benefit of priority from Japanese Patent Application No. 2005-345912, filed Nov. 30, 2005, the entire contents of which are incorporated herein by reference.

### BACKGROUND

1. Field

One embodiment of the invention relates to a multi-AV stream playback method and playback apparatus.

2. Description of the Related Art

In recent years, digitization of audio visual information (AV information) has advanced, and media that record MPEG-encoded AV information are prevalently used. As a typical example of such media, a DVD (digital versatile disc) is known. The standard itself of the DVD has evolved, and the Hi-Vision compatible next-generation DVD standard called HD_DVD (high definition DVD) will be released soon. In this HD_DVD standard, since the recording density is greatly higher than the current-generation DVD, the playback apparatus side is demanded to have corresponding advanced functions. More specifically, the current-generation DVD-Video standard can play back only one program stream, but the HD_DVD standard has a prerequisite for simultaneous playback of two programs which are independently multiplexed and have no temporal relationship (primary program streams which form a primary video set and secondary program streams which form a secondary video set).

More specifically, an optical disc of the HD_DVD standard records a main video signal, sub-video signal, main audio signal, sub-audio signal, and sub-picture signal as primary program streams, and an optical disc player of the HD_DVD standard is configured to selectively play back these five types of primary program streams.

Also, the player of the HD_DVD standard can acquire a main video signal, sub-video signal, main audio signal, and sub-audio signal as secondary program streams, and is configured to selectively replace the sub-video signal and main audio signal and/or sub-audio signal obtained from the optical disc by those obtained from the server and to synchronously play back the obtained signals.

It is known to synchronously play back different data (video and audio data, or video and sub-picture data) in one program stream (see Jpn. Pat. Appln. KOKAI Publication No. 2004-228627). This KOKAI Publication discloses an apparatus which synchronously processes video data and audio data in a special playback mode and normal playback mode. However, this KOKAI Publication has no disclosure about synchronous playback of two program streams (a plurality of independent contents: multi-AV streams in a broader sense) which are independently multiplexed and have no temporal relationship.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram for explaining principal part of a multi-AV stream playback apparatus according to one embodiment of the invention;

FIG. 2 is an exemplary block diagram for explaining an overview of playback synchronization processing in the apparatus shown in FIG. 1;

FIG. 3 is an exemplary view for explaining an example of the data structure of multi-AV streams to be played back by the apparatus shown in FIG. 1; and

FIG. 4 is an exemplary flowchart for explaining an example of the playback synchronization processing in the apparatus shown in FIG. 1.

### DETAILED DESCRIPTION

Various embodiments according to the invention will be described hereinafter with reference to the accompanying drawings. In general, according to one embodiment of the invention, there is provided a method of synchronously playing back primary object data and secondary object data which include data unit groups having playback time information and which are temporally independent and are different from each other. With this method, the playback time information is acquired from the played-back primary object data, and the playback time information is acquired from the played-back secondary object data. Using one of the acquired playback time information of the primary object data and that of the secondary object data, the primary object data and the secondary object data are played back in sync. In this way, synchronous playback of a plurality of independent contents (main AV data and sub AV data having no temporal mutual relationship) may be implemented.

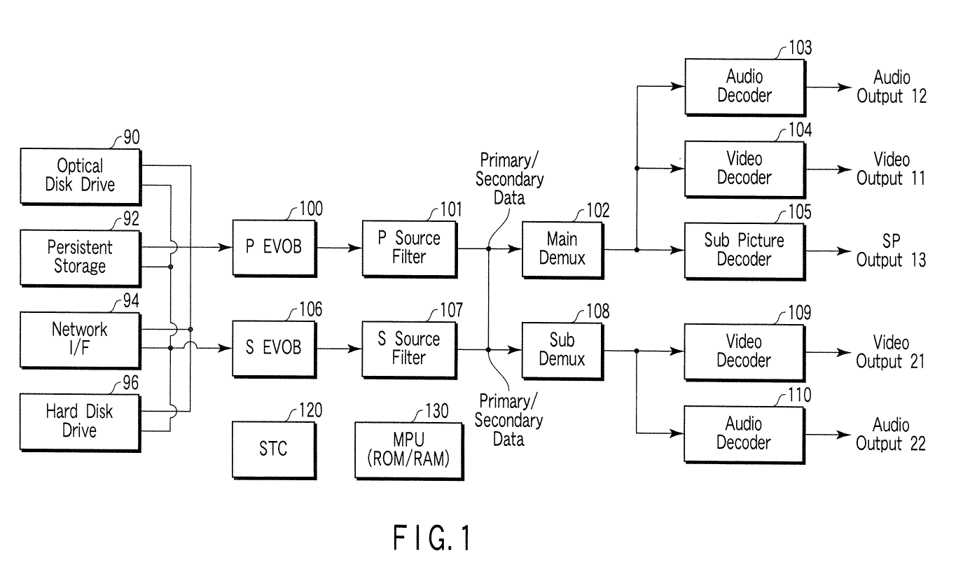

According to an embodiment, FIG. 1 is a block diagram for explaining principal part of a multi-AV stream playback apparatus (data flow of HD_DVD). This apparatus can extract multi-AV streams compliant to the HD_DVD standard from at least one of Optical Disc Drive 90 using a blue laser or the like, Persistent Storage 92 using a large-capacity flash memory or the like, Network I/F 94 configured to connect a contents provider via the Internet or the like, and Hard Disk Drive 96. The operation timing of the overall apparatus shown in FIG. 1 can be determined based on STC (system time clock) 120, and the operation of the overall apparatus is controlled by MPU 130.

Input data to the system configuration of the apparatus shown in FIG. 1 are provided as primary enhanced video object P-EVOB 100 and secondary enhanced video object S-EVOB 106. These data are respectively buffered by Primary Source Filter 101 and Secondary Source Filter 107, and are then supplied to Main Demux 102 and Sub Demux 108. The data separated (demultiplexed) by Main Demux 102 and Sub Demux 108 are respectively sent to and decoded by Main Decoders 103 to 105 and Sub Decoders 109 to 110. Note that main data in the P-EVOB is sent to Main Demux 102, and sub data is sent to Sub Demux 108. Likewise, main data in the S-EVOB is sent to Main Demux 102, and sub data is sent to Sub Demux 108.

Of Main Decoders 103 to 105 and Sub Decoders 109 to 110, the video decoders (104, 109) decode video information encoded by methods such as MPEG2, MPEG4, VC-1, and the like. Also, the audio decoders (103, 110) decode audio information encoded by methods such as AC-3(R), DTS(R), L-PCM, and the like in addition to MPEG. Furthermore, the sub-picture decoder (105) decodes bitmap information encoded by a method (runlength compression using special codes) specified by the HD_DVD standard.

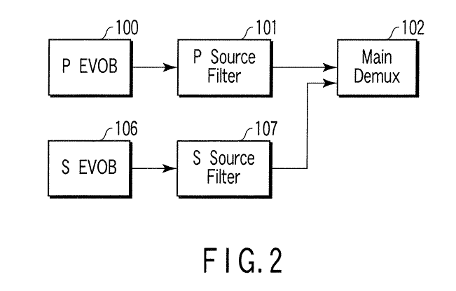

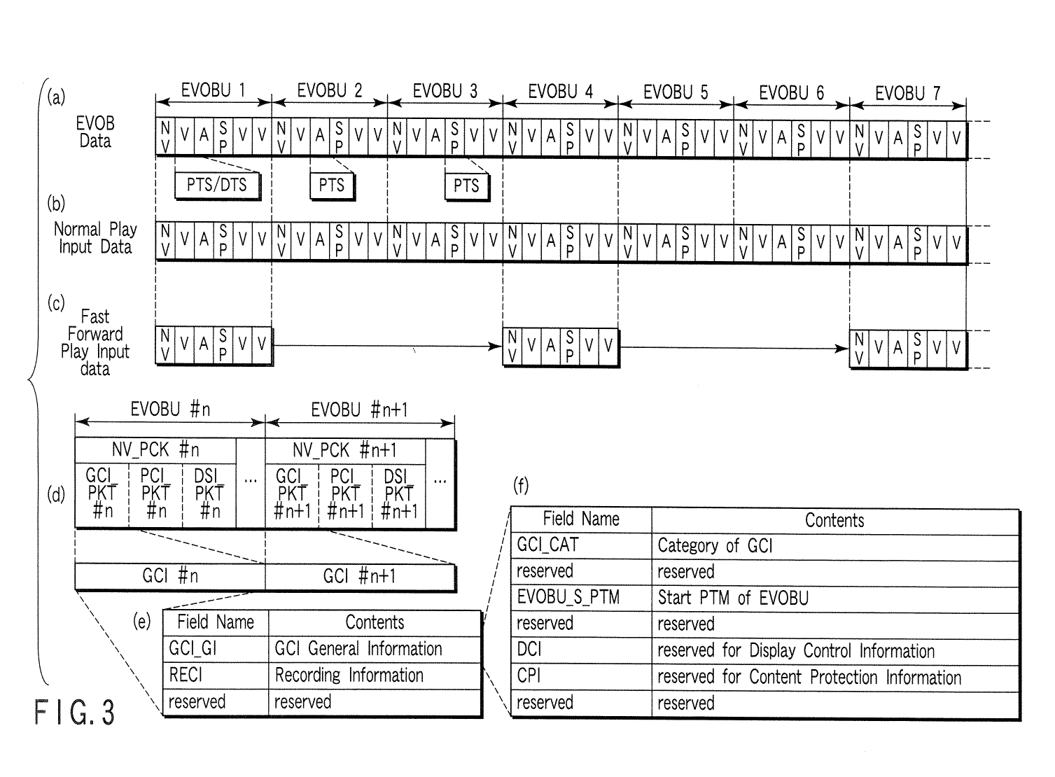

FIG. 2 is a block diagram for explaining an overview (different file input connection diagram) of playback synchronization processing in the apparatus of FIG. 1. When normal play is to be made in the system of the apparatus shown in FIG. 1, system clock data is calculated based on time information (PTS or EVOBU_S_PTM shown in FIG. 3) included in data (P-EVOB and S-EVOB) sent to Main Demux 102, and STC 120 is set based on the calculation result. Since both the Main Demux 102 side and Sub Demux 108 side operate at timings based on identical STC 120, synchronous playback of the P-EVOB and S-EVOB is guaranteed.

In the playback system shown in FIG. 1, in addition to normal play, playback modes such as slow play, play pause, step play, fastforward (FF) play, fastreverse (FR) play, and the like are available. These playback modes include STC controlled states such as normal, slow, pause, step, and the like, and STC non-controlled states (STC free states) such as fastforward, and the like. The STC controlled state is a mode that plays back data with reference to the STC, and the STC non-controlled state is a mode that plays back data without referring to the STC. In the HD_DVD, synchronous playback is made even in the STC non-controlled state (STC free state) to synchronize main data and sub data.

For example, upon transition from fastforward (FF) or fastreverse (FR) (STC non-controlled/STC free) to normal play (STC controlled), playback starts with reference to time data generated based on main data again. In this case, when the decode speed of sub data in the FF play mode is higher than main data, since the sub data has passed the playback start time of the main data, playback of the sub data starts by returning to the playback start time of the main data. For this reason, synchronous playback is needed in the FF play mode.

FIG. 3 is a view for explaining an example of the data structure of multi-AV streams to be played back by the apparatus shown in FIG. 1. Each EVOB includes a plurality of data units (enhanced video object units: EVOBUs) (FIG. 3(a)). In each EVOBU, navigation pack NV is allocated at the head of the EVOBU, and a predetermined number of video packs V, audio packs A, and sub-picture packs SP are appropriately allocated after navigation pack NV. Each EVOBU has a size corresponding to the playback time of 0.4 to 1.0 sec (note that the EVOBU at the end of the EVOB has a size corresponding to the playback time of 0.4 to 1.2 sec). Optical disc drive 90 in FIG. 1 is configured to access an arbitrary EVOBU from an NV pack at its head position. In the normal play mode, respective EVOBUs are played back in turn (FIG. 3(b)). In the fastforward (FF) play mode, some EVOBUs are played back at intervals (e.g., at a rate of every third EVOBUs) (FIG. 3(c)).

Multi-AV streams include a plurality of systems of program streams which are independently multiplexed, and have no temporal relationship. In case of HD_DVD standard, the multi-AV streams include primary program streams which form a primary video set, and secondary program streams which form a secondary video set. The primary program streams include a main video stream, main audio streams, sub video stream, sub audio streams, sub-picture streams, and advanced streams. Also, the secondary program streams include a main video stream, main audio stream, sub video stream, and sub audio stream. Each of these streams is completed within one object (enhanced video object: EVOB).

In case of both the primary video set and secondary video set, the main and sub video streams are stored in video pack V, and the main and sub audio streams are stored in audio pack A. Likewise, the sub-picture streams are stored in sub-picture pack SP. Video pack V has a header including presentation time stamp PTS and decode time stamp DTS. Audio pack A has a header including presentation time stamp PTS. Also, sub-picture pack SP has a header including presentation time stamp PTS.

Navigation pack NV (NV_PCK#n in FIG. 3(d)) allocated at the head of each EVOBU records general control information GCI, which has its general information GCI_GI (FIG. 3(e)). This GCI_GI includes information EVOBU_S_PTM indicating the playback start time of the EVOBU which has at its head position the NV pack that includes the GCI_GI, display control information DCI, contents protection information (copy control information) CPI, and the like (FIG. 3(f)).

Playback time information (EVOBU_S_PTM) in the GCI can be used to attain synchronous playback of information (P-EVOB) of the primary video set and that (S-EVOB) of the secondary video set. Also, playback time information (PTS) in packs (V packs and A packs) which store the main and sub video streams, and main and sub audio streams, can be used to attain synchronous playback of these streams.

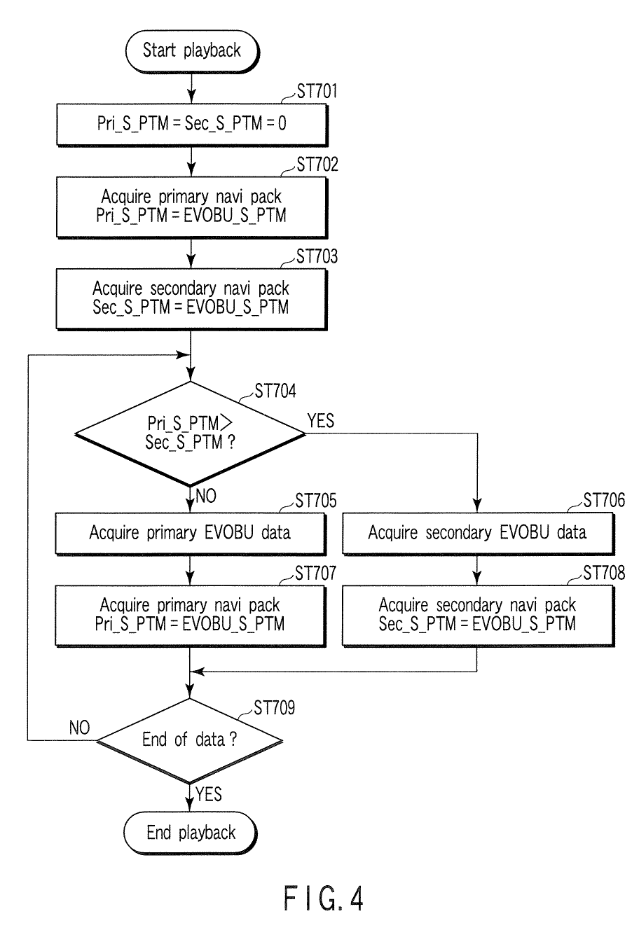

FIG. 4 is a flowchart for explaining an example of playback synchronization processing (data acquisition flow) in the apparatus shown in FIG. 1. This processing can be written as firmware in a ROM equipped in MPU 130 in FIG. 1.

In the system configuration shown in FIGS. 1 and 2, registers (not shown) of time parameters (Pri_S_PTM for the primary video set and Sec_S_PTM for the secondary video set) in the system are reset to zero (block ST701). After that, in order to synchronize temporally independent different input files (P-EVOB and S-EVOB), pieces of playback time information (EVOBU_S_PTM in an NV pack of the P-EVOB and that in an NV pack of the S-EVOB) in EVOBUs of the P-EVOB and S-EVOB are acquired by Demux 102 of the data input stage.

The acquired playback time information value is set in the register of time parameter Pri_S_PTM (block ST702), and the acquired playback time information value is set in the register of time parameter Sec_S_PTM (block ST703). Note that these time parameter registers can be assured on a part of a RAM area equipped in MPU 130 in FIG. 1.

The values of Pri_S_PTM and Sec_S_PTM are compared (block ST704). That is, as shown in FIGS. 3D to 3F, playback time information EVOBU_S_PTM is described in the GCI in the navigation pack (NV_PCK), and that data is interpreted by the Demux. The primary and secondary sides hold the interpreted values and compare them.

Based on the comparison result, if the playback start time (Pri_S_PTM) of the P-EVOB has already passed at the playback start timing (Sec_S_PTM) of the S-EVOB (YES in block ST704), Demux 102 acquires EVOBU data (FIG. 3(a)) of the S-EVOB at that timing (block ST706). Playback time information (EVOBU_S_PTM) in an NV pack of that EVOBU is set in the register of time parameter Sec_S_PTM (block ST708). Then, the EVOBU including the set playback time information is supplied to subsequent-stage buffers (decoders).

On the other hand, if the playback start time (Sec_S_PTM) of the S-EVOB has already passed at the playback start timing (Pri_S_PTM) of the P-EVOB (NO in block ST704), Demux 102 acquires EVOBU data (FIG. 3(a)) of the P-EVOB at that timing (block ST705). Playback time information (EVOBU_S_PTM) in an NV pack of that EVOBU is set in the register of time parameter Pri_S_PTM (block ST707). Then, the EVOBU including the set playback time information is supplied to subsequent-stage buffers (decoders).

The above operations are repeated while more input data of the P-EVOB or S-EVOB remain (NO in block ST709). During this interval, the P-EVOB and S-EVOB can be played back in sync (synchronous playback) by supplying data to the subsequent-stage buffers (decoders) using one of the playback time information of the P-EVOB and that of the S-EVOB (if YES in block ST704, EVOBU_S_PTM=Sec_S_PTM; if NO in block ST704, EVOBU_S_PTM=Pri_S_PTM).

### SUMMARY OF EMBODIMENT

1) In an HD_DVD player, if there are two AV streams, i.e., main and sub streams, they are synchronously played back. In the HD_DVD standard, a secondary EVOB is to be played back in addition to a primary EVOB, and each of these data include Main Decoder data and Sub Decoder data. Data which need be simultaneously played back in stream playback of the primary EVOB (main, sub) and secondary EVOB (main, sub) are one main data and one sub data. Two decoders are used to play back these data. Hence, the source filters which separate data are inserted between connections of the primary EVOB file and secondary EVOB file, and the separated data are output to the corresponding Main Demux and Sub Demux.

2) In the normal play (normal speed play) mode, synchronization is attained using one clock data (STC) generated based on main data so as to control the two streams. A playback combination pattern includes a combination for playing back main video data of the primary EVOB and main audio data of the secondary EVOB. Originally, in DVD playback, video and audio data which are multiplexed in advance for the purpose of synchronous playback are used and played back. In HD_DVD, data acquired from different files need be synchronously played back. The Demux interprets time information (time stamp) for playback to make input control in the Demux and streams are supplied to the subsequent-stage decoder in synchronism with the time information (time stamp), thus allowing synchronous playback. In this way, a system which synchronously outputs two contents is novel and useful.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modification as would fall within the scope and spirit of the inventions.

What is claimed is:

1. A method of synchronously playing back primary object data and secondary object data, which include groups of data units having playback time information, and are temporally independent and different from each other, comprising:
acquiring playback time information from the played-back primary object data;
acquiring playback time information from the played-back secondary object data; and
synchronously playing back the primary object data and the secondary object data using one playback time information of the acquired playback time information of the primary object data and the acquired playback time information of the secondary object data.

2. The method according to claim 1, wherein each of the primary object data and the secondary object data include main video data, main audio data, sub video data, and sub audio data, and
information of the main video data of the primary object data or the main audio data of the secondary object data is decoded based on one type of the playback time information.

3. A playback apparatus comprising:
an information playback unit configured to play back primary object data and secondary object data, which include groups of data units having playback time information, and are temporally independent and different from each other; and
a playback control circuit configured to acquire playback time information from the played-back primary object data, to acquire playback time information from the played-back secondary object data, and to synchronously play back the primary object data and the secondary object data using one playback time information of the acquired playback time information of the primary object data and the acquired playback time information of the secondary object data.

4. The apparatus according to claim 3, wherein each of the primary object data and the secondary object data include main video data, main audio data, sub video data, and sub audio data, and
the information playback unit is configured to include a filter configured to separate data streams of the primary object data and data streams of the secondary object data, a main demultiplexer configured to extract information of the main video data and/or main audio data from the data streams of the primary object data and/or the data streams of the secondary object data separated by the filter, and a sub demultiplexer configured to extract information of the sub video data and/or sub audio data from the data streams of the secondary object data separated by the filter.

5. The apparatus according to claim 4, wherein information of the main video data and information of the main audio data are encoded by predetermined methods, and the information playback unit is configured to include a main decoder which contains a main video decoder configured to decode the main video data, and a main audio decoder configured to decode the main audio data.

6. The apparatus according to claim 5, wherein information of the sub video data and information of the sub audio data are encoded by predetermined methods, and the information playback unit is configured to include a sub video decoder configured to decode the sub video data, and a sub audio decoder configured to decode the sub audio data.

7. The apparatus according to claim 5, wherein the main demultiplexer is configured to extract information of the main video data of the primary object data and the main audio data of the secondary object data, and
the main demultiplexer is configured to supply the information of the main video data of the primary object data and the main audio data of the secondary object data to the main decoder based on a system clock being time-set by one type of the playback time information.

8. The apparatus according to claim 6, wherein the main demultiplexer is configured to extract information of the main video data of the primary object data and the main audio data of the secondary object data, and
the main demultiplexer is configured to supply the information of the main video data of the primary object data and the main audio data of the secondary object data to the main decoder based on a system clock being time-set by one type of the playback time information.
